(19) United States
(12) Patent Application Publication
(10) Pub. No.: US 2026/0104484 A1
(43) Pub. Date: Apr. 16, 2026

(54) METHOD AND SYSTEM OF TIME-FREQUENCY-CODE SENSOR CODING FOR INTERFERENCE MITIGATION IN A VEHICLE

(71) Applicant: GM GLOBAL TECHNOLOGY OPERATIONS LLC, Detroit, MI (US)

(72) Inventors: Oren Longman, Tel Aviv (IL); Gaston Solodky, Kfar Sava (IL)

(73) Assignee: GM GLOBAL TECHNOLOGY OPERATIONS LLC, Detroit, MI (US)

(21) Appl. No.: 18/911,612

(22) Filed: Oct. 10, 2024

(51) Int. Cl. G01S 7/02; G01S 7/35; G01S 13/931

(52) U.S. Cl. CPC G01S 7/023; G01S 7/356; G01S 13/931

(57) ABSTRACT

A system and method for time-frequency coding with code-division multiple access (CDMA) for interference mitigation of vehicle sensors is presented that includes generating and transmitting, from a vehicle, a first chirp signal by a first sensor, in a first channel and a second chirp signal by a second sensor, in a second channel. Both the first and the second channels include a time-channel component, a frequency-channel component, and a code dimension. A first sensor receives a first reflection signal, and a second sensor receives a second reflection signal, each from one or more objects. In addition, the second channel includes one or more different time channels, different frequency channels, or different code dimensions from the first channel, and the code dimension of the first channel and the code dimension of the second channel are determined, from a set of code dimensions, based on a lowest interference noise estimation.

### INTRODUCTION

Vehicles are rapidly integrating ever increasing technological components into their systems. Special use microcontrollers, technologies, and sensors may be used in many different applications in a vehicle. Automotive microcontrollers and sensors may be utilized in enhancing automated structures that offer state-of-the-art experience and services to the customers, for example in tasks such as body control, camera vision, information display, security, autonomous controls, etc. Further, functions such as adaptive cruise control, lane change assist, and vehicle proximity detection may use a variety of sensors using light detection and ranging (LIDAR), radio detection and ranging (RADAR), ultrasonic, and other wireless technologies to accomplish their functions.

However, with the prolific use of such wireless detection and communication sensors there is an ever-increasing possibility of interference between various vehicles and their systems. Thus, the ability to mitigate interference such that vehicle systems may operate successfully is critical.

### SUMMARY

Disclosed herein is a vehicular system and method of time-frequency coding with code-division multiple access (CDMA) for interference mitigation of vehicle sensors. As disclosed herein, a sensor may contain components that are configured to transmit multiple signals, either simultaneously or overlapping in time, while also configured to receive multiple concurrent signals. Further, a single sensor or sensor assembly may include multiple sensors each with the ability to generate, transmit, and receive signals.

Thus, a system of time-frequency coding with CDMA for interference mitigation of vehicle sensors may include one or more sensors, where for example a first sensor located within a vehicle may be used to generate and transmit a first chirp signal. The first chirp signal may be transmitted in a first channel, where the first channel includes a time-channel, a frequency-channel, and a code dimension. The first sensor may also receive a first reflection signal from one or more objects from the first chirp signal. Further, a second sensor may generate and transmit a second chirp signal in a second channel, where the second channel may include a time-channel, a frequency-channel, and a code dimension, where the sensor may also receive a second reflection signal from one or more objects from the second chirp signal. Further, the second channel may consist of one or more different time channels, different frequency channels, or different code dimensions from the first channel. In addition, the code dimension of the first channel and the code dimension of the second channel may be determined from a set of code dimensions based on a lowest interference noise estimation.

Another aspect of the disclosure may include a third sensor that may be used to generate a waveform allocated across a plurality of time-frequency-channels.

In another aspect of the disclosure the second sensor may enter a listening mode to determine an interference noise estimation for each code dimension in the set of code dimensions.

In another aspect of the disclosure the first sensor and the second sensor are time synchronized.

In another aspect of the disclosure a first code dimension is semi-orthogonal to a second code dimension in the set of code dimensions.

In another aspect of the disclosure a processing logic to determine a noise level of the first reflection signal, wherein the noise level is stored in a memory including a time decay mechanism.

In another aspect of the disclosure the noise level is greater than a threshold, the first sensor may generate a subsequent chirp signal in a third channel.

In another aspect of the disclosure when a noise level is greater than a threshold level a current channel may be categorized as occupied.

In another aspect of the disclosure the first sensor and the second sensor may not transmit on an occupied frequency channel.

Another aspect of the disclosure may further include a processing logic to perform a first noise estimation based on a range fast Fourier transform (FFT) and a Doppler FFT before a digital beamforming on the first reflection signal, and to perform a second noise estimation based the range fast Fourier transform (FFT) before the Doppler FFT on the first reflection signal. In another aspect of the disclosure the second sensor is not located in the vehicle.

In another aspect of the disclosure the first sensor and the second sensor utilize the use of radar, Lidar, or ultrasonic frequencies.

Another aspect of the disclosure may include a method for time-frequency coding with CDMA for interference mitigation of vehicle sensors. Such a method may include generating and transmitting, from a vehicle, a first chirp signal by a first sensor, in a first channel, where the first channel may include a time-channel, a frequency-channel, and a code dimension. The method may also include generating and transmitting, a second chirp signal by a second sensor, in a second channel, where the second channel may include a time-channel, a frequency-channel, and a code dimension. The method may also include receiving, by the first sensor, a first reflection signal from one or more objects from the first chirp signal, and by also receiving, by the second sensor, a second reflection signal from one or more objects from the second chirp signal. However, the second channel may include one or more different time channels, different frequency channels, or different code dimensions from the first channel, and also where the code dimension of the first channel and the code dimension of the second channel may be determined, from a set of code dimensions, based on a lowest interference noise estimation.

Another aspect of the disclosure may include listening, by the second sensor, to determine an interference noise estimation for each code dimension in the set of code dimensions.

Another aspect of the disclosure may include time synchronizing the first sensor and the second sensor.

Another aspect of the disclosure may include where a first code dimension is semi-orthogonal to a second code dimension in the set of code dimensions.

Another aspect of the disclosure may include determining, by a processing logic, a noise level of the first reflection signal, where the noise level may be stored in a memory including a time decay mechanism.

Another aspect of the disclosure may include categorizing, when the noise level is greater than a threshold level, a current time-frequency channel as occupied.

Another aspect of the disclosure may include performing a first noise estimation based on a range fast Fourier transform (FFT) and a Doppler FFT before a digital beamforming on the first reflection signal, and may also perform a second noise estimation based on the range fast Fourier transform (FFT) before the Doppler FFT on the first reflection signal.

Another aspect of the disclosure may include where the first sensor and the second sensor may not transmit on an occupied frequency channel.

Another aspect of the disclosure may include where the first sensor and the second sensor may utilize the use of radar, Lidar, or ultrasonic frequencies.

Another aspect of the disclosure may include a method for time-frequency coding with CDMA for interference mitigation of vehicle sensors that includes generating and transmitting, from a vehicle, a first chirp signal by a first sensor, in a first channel, where the first channel may include a time-channel, a frequency-channel, and a code dimension. The method may further include generating and transmitting, a second chirp signal by a second sensor, in a second channel, where the second channel may include a time-channel, a frequency-channel, and a code dimension. The method may include receiving, by the first sensor, a first reflection signal from one or more objects from the first chirp signal and may also include receiving, by the second sensor, a second reflection signal from one or more objects from the second chirp signal. The method may include listening, by the second sensor, to determine an interference noise estimation for each code dimension in the set of code dimensions and to also include determining, by a processing logic, a noise level of the first reflection signal, where the noise level is stored in a memory including a time decay mechanism. The method may also include performing a first noise estimation based on a range fast Fourier transform (FFT) and a Doppler FFT before a digital beamforming on the first reflection signal, and may also include performing a second noise estimation based the range fast Fourier transform (FFT) before the Doppler FFT on the first reflection signal. The method may include where the second channel may include one or more different time channels, different frequency channels, or different code dimensions from the first channel, and also where the code dimension of the first channel and the code dimension of the second channel may be determined, from a set of code dimensions, based on a lowest interference noise estimation.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIGS. 1A and 1B are illustrations of multi-vehicle situations with interfering sensor signals, in accordance with the disclosure.

FIG. 2 is an illustration of a multi-zone vehicle sensor interference scenario, in accordance with the disclosure.

FIG. 3 is an illustration of a time-frequency sensor system with CDMA configuration, in accordance with the disclosure.

FIG. 4 is an illustration of a time-frequency-coding sensor channel, in accordance with the disclosure.

FIG. 5 is an illustration of a code margin of linear frequency modulation, in accordance with the disclosure.

FIG. 6 is an illustration of a multiple time-frequency channel waveform, in accordance with the disclosure.

FIG. 7 is an illustration of a multiple time-frequency plot with noise, in accordance with the disclosure.

FIG. 8 is an illustration of a listening mode of in use codewords, in accordance with the disclosure.

FIG. 9 depicts a flowchart of a method for time-frequency coding with CDMA for interference mitigation of sensors, in accordance with the disclosure.

The appended drawings are not necessarily to scale and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

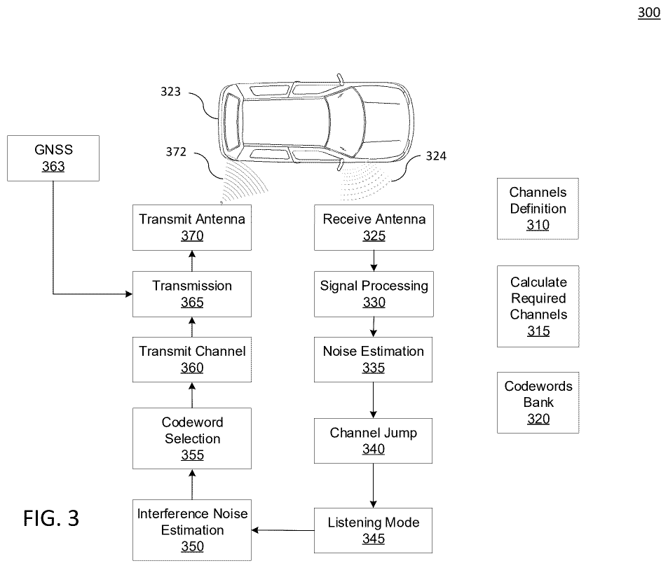

Referring to the drawings, the left most digit of a reference number identifies the drawing in which the reference number first appears (e.g., a reference number ‘310’ indicates that the element so numbered is first labeled or first appears in FIG. 3). Additionally, elements which have the same reference number, followed by a different letter of the alphabet or other distinctive marking (e.g., an apostrophe), indicate elements which may be the same in structure, operation, or form but may be identified as being in different locations in space or recurring at different points in time (e.g., reference numbers “110a” and “110b” may indicate two different input devices which may be functionally the same, but may be located at different points in a simulation arena).

Autonomous vehicle and advanced driver assistance systems (AV/ADAS) such as adaptive cruise control, automated parking, automatic brake hold, automatic braking, evasive steering assist, lane keeping assist, adaptive headlights, backup assist, blind spot detection, cross traffic alert, local hazard alert, and rear automatic braking may depend on information obtained from cameras and sensors on a vehicle. As these types of features become more prevalent in vehicles the sensors that are relied on to enable such features are susceptible to radiation interference from other vehicles. This interference may lead to false alarms or the masking of true targets which in turn may degrade a system's performance that depends on sensor information. The severity of interference in a sensor may also be a function of the number of sensors in a given area. Thus, as AV/ADAS system become more prevalent, sensors within each vehicle become mission critical components requiring high reliability.

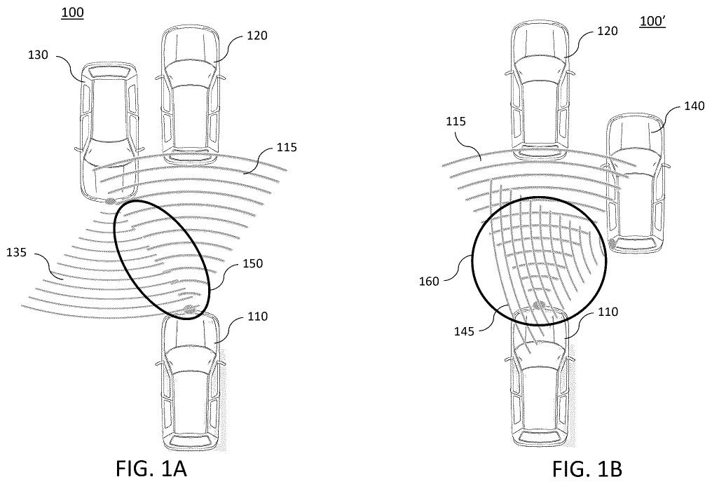

FIGS. 1A and 1B are illustrations of multi-vehicle situations 100 and 100′ with possible interfering sensor signals, according to an embodiment of the present disclosure. In FIG. 1A, victim vehicle 110 is emitting, or transmitting, radiation signal 115, e.g., radar, lidar, or ultrasonic, towards a target vehicle 120. However, oncoming vehicle 130, that may also be equipped with a transmitting sensor and thus may also emit a radiation signal 135. Accordingly, there may be an interference region 150 in which victim vehicle 110 may receive radiation signal 135 instead of an expected reflected signal from its radiation signal 115 that may have been reflected off of the target vehicle 120. Such interference may result in false readings, possibly negating the desired reflected signal entirely. FIG. 1B illustrates a comparable situation where the victim vehicle 110 may receive a radiation signal 145 from an adjacent vehicle 140 thus generating an interference region 160. Sensors may operate at a variety of frequencies, or frequency ranges, and therefore especially if radiation signal 115 and radiation signal 135 or radiation signal 145 are operating at the same, or similar frequencies, the resulting interference may produce extremely undesirable results.

Sensor signals, for example radiation signal 115, may be produced as a number of chirp signals. Chirp signals may be defined as a signal in which the frequency increases, e.g., an up-chirp, or decreases (down-chirp) with time. In some embodiments, the term chirp may be used interchangeably with a sweep signal and may be applied to sonar, radar, and laser systems, and also may be used in spread-spectrum communications.

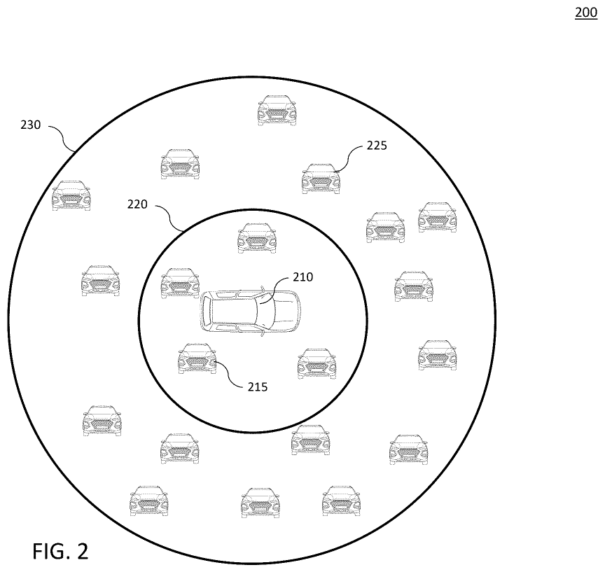

FIG. 2 is an illustration of a multi-zone vehicle interference scenario 200, according to an embodiment of the present disclosure. Scenario 200 may be envisioned where vehicle 210 may be surrounded by numerous other vehicles. These other vehicles 215 may be categorized as those close to vehicle 210 within an inner zone 220 and another set of vehicles 225 as existing further away from vehicle 210 within an outer zone 230. The vehicles 215 (the vehicles within inner zone 220 may be referred to collectively as vehicles 215) within inner zone 220 may also be equipped with transmitting sensors and due to their proximity with vehicle 210, vehicle 210 is the recipient of numerous relatively strong radiation signals emitted from vehicles 215. However, while these received radiation signals may be relatively strong, there may be far fewer vehicles as compared to the quantity of vehicles 225 (the vehicles within outer zone 230 may be referred to collectively as vehicles 225) within the outer zone 230. To mitigate interference between vehicle 210 and the inner zone vehicles 215 the use of time-frequency sensor coding, as described in U.S. Patent Publication No. 2024/0201319, titled Method and System of Time-Frequency Sensor Coding for Interference Mitigation in a Vehicle, which is incorporated by reference in its entirety, may offer an optimal solution for interference mitigation.

However, the area in outer zone 230, compared to the area in inner zone 220, may have the potential to contain a much larger number of vehicles capable of emitting radiation signals, as compared to the number of vehicles within inner zone 220. While vehicle 210 may physically be somewhat distanced from outer zone 230 and hence the received signals from vehicles in outer zone 230 may be somewhat weaker, there is still the potential for receiving numerous signals from outer zone 230 vehicles and hence there may be the potential for an increased level of signal interference. In such a scenario the use of being restricted to using time-frequency sensor coding for interference mitigation may not offer an optimal number of available channels to accommodate the quantity of vehicles 225 in outer zone 230. Accordingly, this disclosure is directed to the use of CDMA with time-frequency sensor coding to utilize an additional number of channels for interference mitigation. The number of channels in a time-frequency coding scheme may be extended by incorporating orthogonal signal coding, yielding time-frequency-code channels.

Such coding may include intra-pulse coding over a monotonic and injective frequency modulation frequency function, for example, a phase over linear frequency modulation (LFM), frequency, or hybrid coding. While the time-frequency dimensions may be fully orthogonal, the code dimensions may include semi-orthogonality.

FIG. 3 is an illustration of a possible process flow 300 of a time-frequency sensor system with CDMA, according to an embodiment of the present disclosure. Process flow 300 may include a channels definition 310 component, a calculate required channels 315 component, a codewords bank 320, a channel jump 340 component, a listening mode 345 component, an interference noise estimation 350 component, a codeword selection 355 component, and a time source GNSS 363 (global navigation satellite system) component. In addition, process flow 300 may include, for signal transmission, a transmit channel 360, a transmission 365 component, a transmit antenna 370 to transmit, or broadcast a waveform signal 372. The waveform signal 372 may then be reflected off an object, for example target vehicle 323, and returned as reflected signal 324. On the receiving side, process flow 300 may also include a receive antenna 325, a signal processing 330 component, and a noise estimation 335 component.

Process flow 300 may be directed to defining and tailoring time-frequency-coding channels according to the signal's frequency modulation thereby enabling overlapping transmission of multiple signals and increasing the number of time channels while remaining orthogonal. In addition, process flow 300 may mitigate channel collision by interference estimation and channel jumping. Further, in some embodiments, each sensor is allocated to a frequency channel, thus avoiding interference from other channels. A more detailed explanation of each component follows.

Process flow 300 may start with channels definition 310, where the definition of a channel may include a time component, a frequency component, and a semi-orthogonal code dimension channel component. Process flow 300 may include a time-frequency coding scheme that may be modified to incorporate coding by transmitting a coded signal. For example, after a time-frequency channel jump, initiated by a high noise level or interference detection, a new time-frequency channel undergoes listening to find existing codewords. Then, a codeword may be selected for transmission by the sensor according to the code channel that has the lowest noise.

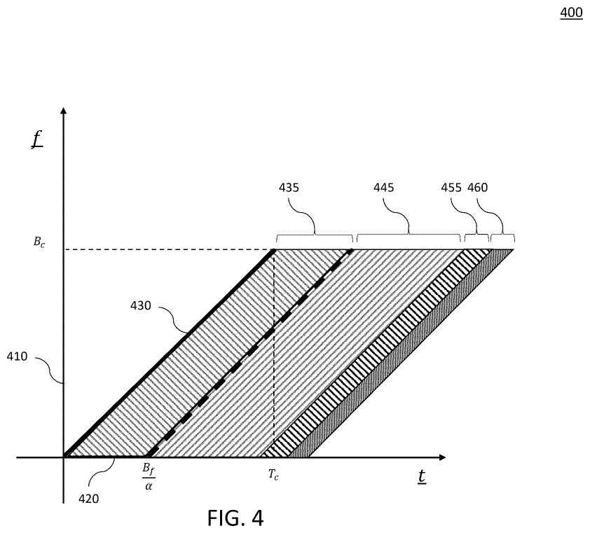

The channel definition 310 component may be directed to an efficient definition of channels based on the particular characteristics of the waveform being used thus enabling a time efficient channel allocation. The channel definition 310 component is illustrated in FIG. 4, showing a time-frequency channel 400, according to an embodiment of the present disclosure. Channel 400, shown as graphed on a vertical frequency axis 410 and a horizontal time axis 420. Channel 400 may also include a waveform, here illustrated as a chirp signal 430 with a chirp duration of T_{c}, with a bandwidth B_{c} and a chirp slope of α=B_{c}/T_{c}. Channel 400 also illustrates four other time components of a possible channel, for example, a signal reception time or a signal reception window, calculated as B_{f}/α and labeled as reception time 435, a propagation time 445, a synchronization margin 455, and a code margin 460.

A channel may be defined, assuming a linear Frequency Modulated (LFM) signal with a chirp duration of T_{c}, a bandwidth B_{c}, and a chirp slope of α=B_{c}/T_{c}, with a pulse repetition interval (PRI) of T_{R}. Each signal may be transmitted in its own timeslot that may be defined by the duration of the signal, in other words with no overlap in time with another signal. Process flow 300 may utilize a different time channel coding that considers a low-pass filter inserted into a sensor's hardware reception time of B_{f}/α, the reception frequency window may vary during the chirp duration by mixing the received signal with a reference signal, a process that may be referred to as stretch-processing. In addition to a maximal propagation delay between two of the most distant relevant signal sources, e.g., radars, categorized as τₘₐₓ and a time synchronization accuracy categorized as δ. In addition, an additional code margin may be added due to an increase in the instantaneous bandwidth as a result of the additional transmitted codewords.

Further, the low-pass filter may be defined by B_{f}, which filters frequency offset higher than B_{f} and may be defined as the sampling frequency.

Thus, the following equation defines the start of the n^{th} time channel:

$${t}_{n} = ( \frac{{B}_{f}}{α} + {τ}_{max} + δ ) \cdot ( n - 1 ) , α = \frac{{B}_{c}}{{T}_{c}}$$

Further, the maximum propagation delay may then be defined according to the required attenuation between signal sources as follows:

$${τ}_{max} = max ( \frac{1}{c} \sqrt{\frac{1}{{( 4 π )}^{2} 1 {0}^{\frac{A}{10}}}} - \frac{{B}_{f}}{α} - δ , 0 )$$

Where A[dB] may be the required attenuation.

In addition, the entire automotive radar spectrum may be exploited to allow for additional transmitting channels shown as:

$${f}_{k} = {f}_{0} + α {T}_{c} k$$

Where f₀ is the start of the allocated spectrum and it is constrained by the allocated spectrum span. A total number of channels may be defined as the number of time channels multiplied by the number of frequency channels. Further, as each time-frequency channel an additional N_{c} codewords may be transmitted. Thus, the total number of channels may be defined as the number of time channels multiplied by the number of frequency channels multiplied by the number of codewords.

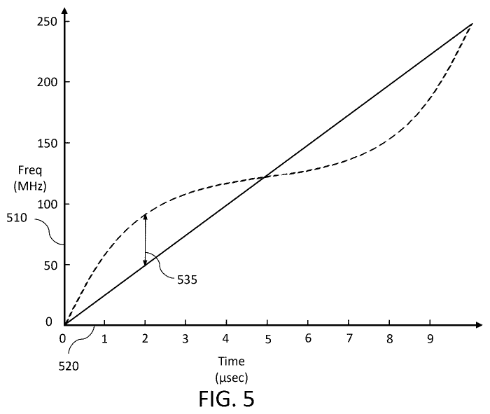

FIG. 5 is an example of the code margin of LFM, according to an embodiment of the present enclosure. FIG. 5 includes an example code margin 535 graphed as a frequency on the vertical axis 510 against the horizontal axis 520 of time.

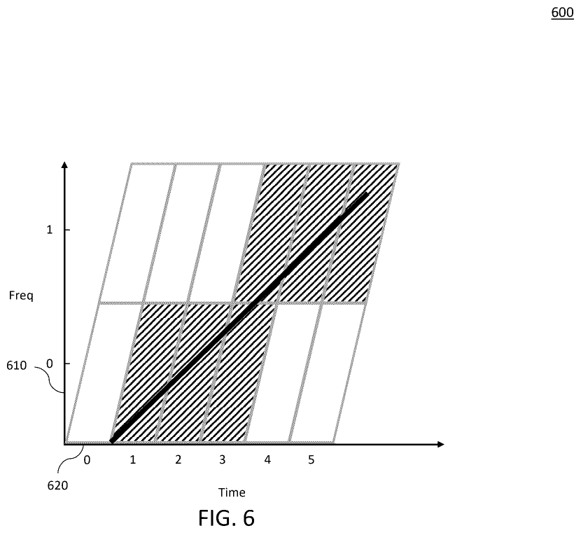

FIG. 6 illustrates a waveform 600 that spans across five time channels and two frequency channels, according to an embodiment of the present disclosure. The graph illustrates the frequency of the signal on the vertical frequency axis 610 versus time on the horizontal time axis 620. The required channel calculation may be defined for a certain waveform consisting of parameters that may include a slope α, a chirp duration T_{c}, a channel time length T_{channel} and a channel bandwidth BW_{channel}.

As an example, for a LFM radar with a different waveform of slope αᵣ and chirp duration T_{(Cr)} the required frequency and time channels may be defined as follows:

$$If {α}_{r} < α :$$

$$j = [ ⌊ i \frac{\frac{B {W}_{c h a n n e l}}{{α}_{r}} - {T}_{c}}{{T}_{c h a nnel}} ⌋ , … , ⌈ ( i + 1 ) \frac{\frac{B {W}_{c h a n n e l}}{{α}_{r}} - {T}_{c}}{{T}_{c h a nnel}} ⌉ ] , 0 \leq i < ⌊ \frac{{α}_{r} {T}_{{c}_{r}}}{B {W}_{c h a n n e l}} ⌋$$

$$j = [ ⌊ i \frac{\frac{B {W}_{c h a n n e l}}{{α}_{r}} - {T}_{c}}{{T}_{c h a nnel}} ⌋ , … , ⌈ \frac{{T}_{{c}_{r}} - {T}_{c}}{{T}_{c h a n n e l}} ⌉ ] , i = ⌊ \frac{{α}_{r} {T}_{{c}_{r}}}{B {W}_{c h a n n e l}} ⌋$$

$$If {α}_{r} > α :$$

$$j = [ ⌊ ( i + 1 ) \frac{\frac{B {W}_{c h a n n e l}}{{α}_{r}} - {T}_{c}}{{T}_{c h a nnel}} ⌋ , … , ⌈ i \frac{\frac{B {W}_{c h a n n e l}}{{α}_{r}} - {T}_{c}}{{T}_{c h a nnel}} ⌉ ] , 0 \leq i < ⌊ \frac{{α}_{r} {T}_{{c}_{r}}}{B {W}_{c h a n n e l}} ⌋$$

$$j = [ ⌊ \frac{{T}_{{c}_{r}} - {T}_{c}}{{T}_{c h a n n e l}} ⌋ , … , ⌈ i \frac{\frac{B {W}_{c h a n n e l}}{{α}_{r}} - {T}_{c}}{{T}_{c h a nnel}} ⌉ ] , i = ⌊ \frac{{α}_{r} {T}_{{c}_{r}}}{B {W}_{c h a n n e l}} ⌋$$

i indicates the frequency channels, j indicates the time channels, initial channel is i=0, j=0 The number of channels used is:

$${N}_{c h a n n e l s} = ⌈ \frac{{T}_{c} + {τ}_{max} + δ}{{T}_{c h a n n e l}} ⌉ + ⌈ \frac{{α}_{r} {T}_{{c}_{r}}}{B {W}_{c h a n n e l}} ⌉ - 1$$

Next, the codewords bank 320 may contain the available codewords. Further, the orthogonality of codewords may also be influenced by the number of used codewords. For example, the use of an adaptive codewords bank may be used where the number of available codewords changes with the number of working radars in a time-frequency channel. Thus, the orthogonality of the codewords may be the same for the codewords in the channel.

Next, signal processing 330 may apply where the transmission 365 component is a waveform signal that may then be transmitted, or broadcast, as a waveform signal 372 through a transmit antenna 370. Waveform signal 372 may then be reflected off an object, for example target vehicle 323, and be returned as reflected signal 324 and received by a receive antenna 325. The received reflected signal 324 may then be processed by a signal processing 330. Signal processing 330, which may also be referred to as radar processing, may perform processing based on a range fast Fourier transform (FFT), a Doppler FFT, and digital beamforming.

Further, noise estimation 335 component may estimate a noise level, using two methods, for each range of channels, after range processing, based on the following:

$${Noise}_{1} = \frac{1}{H L K} {\sum }_{h = 0}^{H - 1} {\sum }_{l = 0}^{L - 1} {\sum }_{k = 0}^{K - 1} R D C [ k , l , h ]$$

$${Noise}_{2} = arg {max}_{k , n , h} \vert RTC [ k , n , h ] \vert - \vert RTC [ k , n - 1 , h ] \vert$$

Where RDC[k, l, h] may be the signal data cube after Range FFT and Doppler FFT, but before digital beamforming. With range dimension k, Doppler dimension l and channel dimension h. H, L, K may represent the number of samples in the range, Doppler, and channel dimensions, respectively. Noise₂ may take advantage that the interferer is not fully time synchronized and may not appear in each of the chirps. Further, the diff function may search for high energy differences due to the interference variation, and thereby may detect it. RTC[k, n, h] may represent the signal data cube after range FFT, but before Doppler FFT.

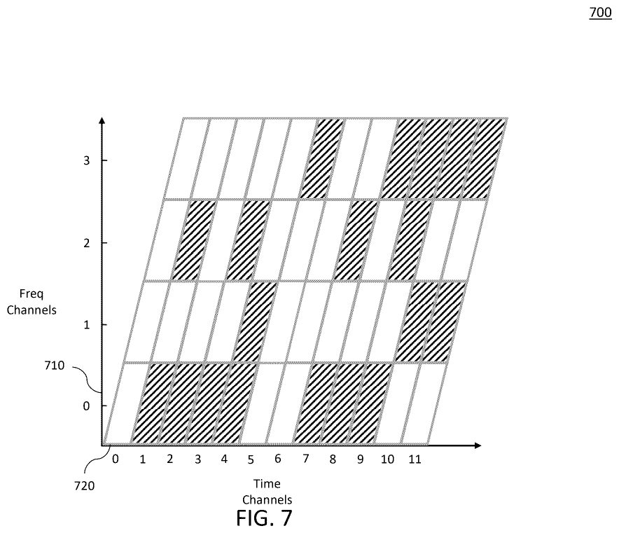

After signal processing 330 and noise estimation 335, the channel jump 340 component may utilize the noise data estimated by noise estimation 335 to determine a new time-frequency-code channel. An example of channel management map 700 is illustrated in FIG. 7, according to an embodiment of the present disclosure. FIG. 7 illustrates the frequency channels on the vertical frequency axis 710 versus time channels on the horizontal time axis 720. For example, FIG. 7 illustrates that time channel 0 may have minimal noise, compared to a threshold, on the illustrated frequency channels. In contrast time channel 1 may indicate noise above a threshold level on frequency channel 0 and 2.

The channel jump 340 component may, based on its received Noise₁ and Noise₂ data exceeding a certain threshold, determine that a particular transmit frequency channel may have an estimated noise level above a predetermined threshold and thus that particular frequency channel may be categorized as occupied.

$${Noise}_{1} = {Threshold}_{1}$$

$${Noise}_{2} = {Threshold}_{2}$$

Further, the associated noise level may be stored in memory, summing the noise measurement Noise₁ and Noise₂. The current channels may be defined as discussed regarding the channels definition 310 component. The channel jump 340 component may mark multiple channels according to noise level as determined by the calculate required channels 315 component accordingly.

A new frequency channel, for example, in the next time channel, may be randomly selected from the available frequency channels, e.g., not the occupied marked frequency channels. However, in an embodiment, if the frequency channels are occupied, channel jump 340 component may select the frequency channel with the lowest noise level as determined in the calculate required channels 315 component. Further, over time the noise level in a particular frequency channel may change. Thus, a noise level decay factor, e.g., δ, may be applied to the FIG. 7 map 700 and may be performed for each new frame in a stream of waveform transmissions. Thus, Map=β·Map. For waveforms consisting of multiple time-frequency channels, multiple channels may be selected in such a manner that the selected channels are unoccupied. If such channels span is not available, the channel span with the lowest average noise may be selected.

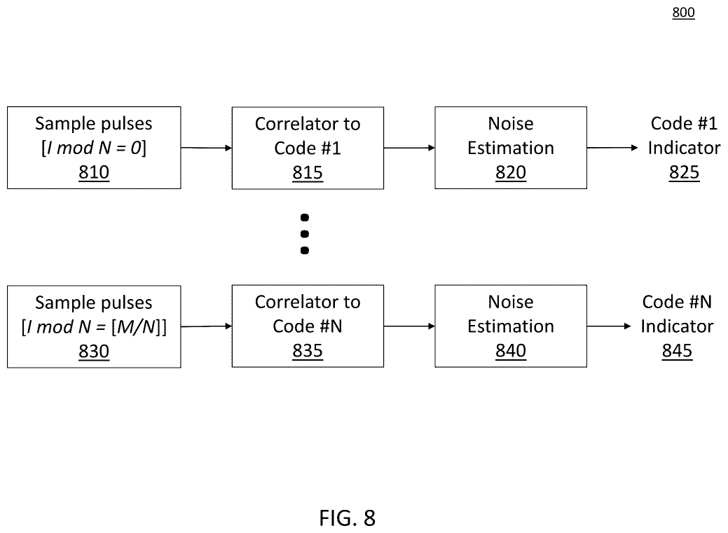

Next, the listening mode 345 component is directed to listening to the codewords that are already in use as designated by the codewords bank 320, for example by using a radar sensor. FIG. 8 is an illustration of a listening mode 800 of in use codewords, according to an embodiment of the present disclosure. Listening mode 345 component may utilize a passive mode, where the frame of M pulses may be divided into N interleaved sub-frames, the total number of codewords in the bank, which are shown as sample pulses 810 through to sample pulses 830. Further, each sub-frame may be matched to a different codeword, which are then each passed through a correlator shown as correlator 815 for code #1 through to correlator 835 for code #N. Each codeword may then be combined with an associated noise estimation, for example noise estimation 820 associated with codeword #1 through to noise estimation 840 associated with codeword N. Then, for each codeword, if the maximal value of a particular codeword and noise is higher than a pre-determined threshold, then that codeword may be determined to be in use. The in-use status may be shown as code #1 indicator 825 through to code #N indicator 845.

Next, the interference noise estimation 350 component may estimate the number of codewords in use in a particular channel and may select the best available codeword. The selected codeword is estimated to comply with an expected performance. However, if the actual performance is less than expected then a codeword in the next family, i.e., with a larger number of transmit radars, may be selected. Such an approach of estimating code noise may incorporate the effect of different orthogonality levels between codewords.

Codeword selection 355 component may include an estimation of noise level for each codeword, after the range processing, which may be estimated by:

$${Noise}_{c o d e w o r d} = max \vert RTC [ k , codeword : N , M , h ] \vert$$

Further, if in the listening mode the interferer is matched, then a peak will indicate occupation of the code channel. And, if the code channel is occupied a new codeword with minimal noise may be selected.

Next, the transmit channel 360 component may store the transmitted channels information. In an embodiment, the initial transmit channel may be chosen randomly. However, the transmit channel may also change due to feedback information from the channel jump 340 component. Transmission 365 component may generate a transmit signal according to the corresponding frequency and time of the transmit channel 360. The frequency and time of the transmit channel 360 may define the initial time and initial frequency of the signal. In addition, transmit channel 360 may receive a time synchronization signal from a global navigation satellite system, e.g., GNSS 363, which is a term meant to describe a satellite constellation that provides positioning, navigation, and timing services on a global or regional basis, e.g., Global Positioning System.

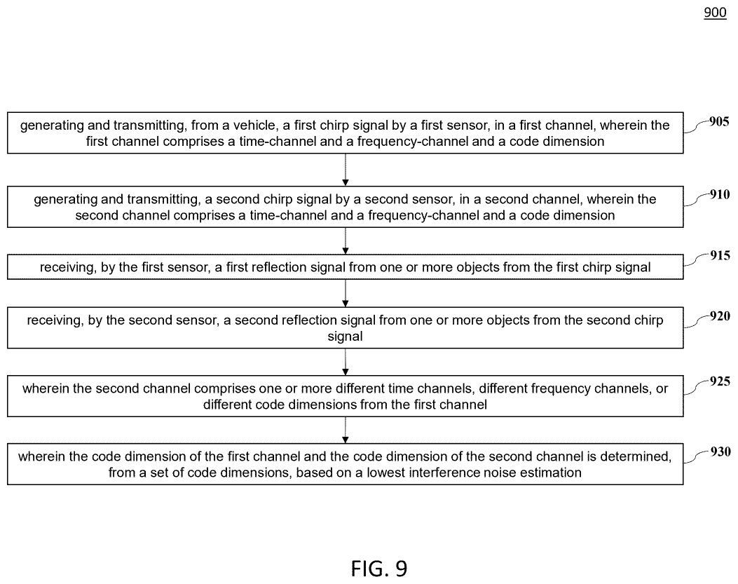

FIG. 9 shows an exemplary embodiment of a method for time-frequency-code interference mitigation of sensors, according to an embodiment of the present enclosure. Method 900 begins at step 905 with generating and transmitting, from a vehicle, a first chirp signal by a first sensor, in a first channel, wherein the first channel includes a time-channel and a frequency-channel and a code dimension. As discussed in FIG. 3, process flow 300 may include a channels definition 310 component, a calculate required channels 315 component, a codewords bank 320, a channel jump 340 component, a listening mode 345 component, an interference noise estimation 350 component, a codeword selection 355 component, and a time source GNSS 363 (global navigation satellite system) component. Channels definition 310 component may include where the definition of a channel may include a time component, a frequency component, and a semi-orthogonal code dimension channel component. The actual determination of a time-frequency-code channel may be accomplished by the calculate required channels 315 component where different type of waveforms may require multiple time and frequency channels as illustrated in FIG. 6. In addition, the codewords bank 320 component may contain the available codewords where the orthogonality of codewords may also be influenced by the number of used codewords. And, in a scenario where a specific time-frequency-code channel becomes noisy or otherwise occupied, the channel jump 340 component may utilize the noise data estimated by noise estimation 335 to determine a new time-frequency-code channel.

Step 910 includes generating and transmitting, a second chirp signal by a second sensor, in a second channel, wherein the second channel includes a time-channel and a frequency-channel and a code dimension. In an embodiment, a different sensor is associated with each channel thereby mitigating interference. However, a sensor may include multiple components to accomplish the same effect, namely producing multiple signal waveforms in different frequency-time-code channels where the signals may not interfere with each other.

At step 915 there may be a receiving, by the first sensor, of a first reflection signal from one or more objects from the first chirp signal. As illustrated in FIG. 3, a generated signal may be transmitted, e.g., by transmission 365 component to the transmit antenna 370 component as waveform signal 372 that may be reflected by one or more objects, such as target vehicle 323, generating a first reflection signal, e.g., reflected signal 324.

At step 920 there may be a receiving, by the second sensor, of a second reflection signal from one or more objects from the first chirp signal. As illustrated in FIG. 3, a generated signal may be transmitted, e.g., by transmission 365 component to the transmit antenna 370 component as waveform signal 372 that may be reflected by one or more objects, such as target vehicle 323, generating a first reflection signal, e.g., reflected signal 324.

At step 925 differences between the first chirp signal and the second chirp signal are further defined. For example, where the second channel includes one or more different time channels, different frequency channels, or different code dimensions from the first channel. As discussed regarding the channels definition 310 component, where the definition of a channel may include a time component, a frequency component, and a semi-orthogonal code dimension channel component. Process flow 300 may include a time-frequency coding scheme that may be modified to incorporate coding by transmitting a coded signal. For example, after a time-frequency channel jump, initiated by a high noise level or interference detection, a new time-frequency channel undergoes listening to find existing codewords. Then, a codeword may be selected for transmission by the sensor according to the code channel that has the lowest noise.

Further, a total number of possible channels may be defined as the number of time channels multiplied by the number of frequency channels. Further, as each time-frequency channel an additional N_{c} codewords may be transmitted. Thus, the total number of channels may be defined as the number of time channels multiplied by the number of frequency channels multiplied by the number of codewords.

At step 930, the choice of code dimension may be defined, where the code dimension of the first channel and the code dimension of the second channel is determined, from a set of code dimensions, based on a lowest interference noise estimation. As discussed, noise estimation 335 component may estimate a noise level, using two methods, for each range of channels, after range processing, based on the following:

$${Noise}_{1} = \frac{1}{H L K} {\sum }_{h = 0}^{H - 1} {\sum }_{l = 0}^{L - 1} {\sum }_{k = 0}^{K - 1} R D C [ k , l , h ]$$

$${Noise}_{2} = arg {max}_{k , n , h} \vert RTC [ k , n , h ] \vert - \vert RTC [ k , n - 1 , h ] \vert$$

Where RDC[k, l, h] may be the signal data cube after Range FFT and Doppler FFT, but before digital beamforming. With range dimension k, Doppler dimension l and channel dimension h. H, L, K may represent the number of samples in the range, Doppler, and channel dimensions, respectively. Noise₂ may take advantage that the interferer is not fully time synchronized and may not appear in each of the chirps. Further, the diff function may search for high energy differences due to the interference variation, and thereby may detect it. RTC[k, n, h] may represent the signal data cube after range FFT, but before Doppler FFT.

Method 900 may then end.

The description and abstract sections may set forth one or more embodiments of the present disclosure as contemplated by the inventor(s), and thus, are not intended to limit the present disclosure and the appended claims.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof may be appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by the above-described exemplary embodiments.

Exemplary embodiments of the present disclosure have been presented. The disclosure is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the disclosure.

What is claimed is:

1. A system of time-frequency coding with code-division multiple access (CDMA) for interference mitigation of vehicle sensors comprising:
a first sensor, in a vehicle, configured to generate and transmit a first chirp signal, in a first channel, wherein the first channel includes a time-channel and a frequency-channel and a code dimension, and to receive a first reflection signal from one or more objects from the first chirp signal; and
a second sensor configured to generate and transmit a second chirp signal in a second channel, wherein the second channel includes a time-channel and a frequency-channel and a code dimension, and to receive a second reflection signal from one or more objects from the second chirp signal,
wherein the second channel includes one or more different time channels, different frequency channels, or different code dimensions from the first channel, and
wherein the code dimension of the first channel and the code dimension of the second channel is determined, from a set of code dimensions, based on a lowest interference noise estimation.

2. The system of claim 1, wherein the second sensor is configured to enter a listening mode to determine an interference noise estimation for each code dimension in the set of code dimensions.

3. The system of claim 1, wherein the first sensor and the second sensor are time synchronized.

4. The system of claim 1, wherein a first code dimension is semi-orthogonal to a second code dimension in the set of code dimensions.

5. The system of claim 1, further comprising a processing logic to determine a noise level of the first reflection signal, wherein the noise level is stored in a memory including a time decay mechanism.

6. The system of claim 5, wherein when the noise level is greater than a threshold, the first sensor is configured to generate a subsequent chirp signal in a third channel.

7. The system of claim 1, wherein when a noise level is greater than a threshold level a current channel is categorized as occupied.

8. The system of claim 1, wherein the first sensor and the second sensor are configured not to transmit on an occupied frequency channel.

9. The system of claim 1, further comprising a processing logic to perform a first noise estimation based on a range fast Fourier transform (FFT) and a Doppler FFT before a digital beamforming on the first reflection signal, and to perform a second noise estimation based the range fast Fourier transform (FFT) before the Doppler FFT on the first reflection signal.

10. The system of claim 1, wherein the second sensor is not located in the vehicle.

11. The system of claim 1, wherein the first sensor and the second sensor utilize the use of radar, Lidar, or ultrasonic frequencies.

12. A method for time-frequency coding with code-division multiple access (CDMA) for interference mitigation of vehicle sensors comprising:
generating and transmitting, from a vehicle, a first chirp signal by a first sensor, in a first channel, wherein the first channel includes a time-channel and a frequency-channel and a code dimension;
generating and transmitting, a second chirp signal by a second sensor, in a second channel, wherein the second channel includes a time-channel and a frequency-channel and a code dimension;
receiving, by the first sensor, a first reflection signal from one or more objects from the first chirp signal; and
receiving, by the second sensor, a second reflection signal from one or more objects from the second chirp signal;
wherein the second channel includes one or more different time channels, different frequency channels, or different code dimensions from the first channel, and
wherein the code dimension of the first channel and the code dimension of the second channel is determined, from a set of code dimensions, based on a lowest interference noise estimation.

13. The method of claim 12, further comprising listening, by the second sensor, to determine an interference noise estimation for each code dimension in the set of code dimensions.

14. The method of claim 12, further comprising time synchronizing the first sensor and the second sensor.

15. The method of claim 12, wherein a first code dimension is semi-orthogonal to a second code dimension in the set of code dimensions.

16. The method of claim 12, further comprising determining, by a processing logic, a noise level of the first reflection signal, wherein the noise level is stored in a memory including a time decay mechanism.

17. The method of claim 12, further comprising, performing a first noise estimation based on a range fast Fourier transform (FFT) and a Doppler FFT before a digital beamforming on the first reflection signal, and to perform a second noise estimation based the range fast Fourier transform (FFT) before the Doppler FFT on the first reflection signal.

18. The method of claim 12, wherein the first sensor and the second sensor are configured not to transmit on an occupied frequency channel.

19. The method of claim 12, wherein the first sensor and the second sensor utilize the use of radar, Lidar, or ultrasonic frequencies.

20. A method for time-frequency coding with code-division multiple access (CDMA) for interference mitigation of vehicle sensors comprising:
generating and transmitting, from a vehicle, a first chirp signal by a first sensor, in a first channel, wherein the first channel includes a time-channel and a frequency-channel and a code dimension;
generating and transmitting, a second chirp signal by a second sensor, in a second channel, wherein the second channel includes a time-channel and a frequency-channel and a code dimension;
receiving, by the first sensor, a first reflection signal from one or more objects from the first chirp signal;
receiving, by the second sensor, a second reflection signal from one or more objects from the second chirp signal;
listening, by the second sensor, to determine an interference noise estimation for each code dimension in the set of code dimensions;
determining, by a processing logic, a noise level of the first reflection signal, wherein the noise level is stored in a memory including a time decay mechanism; and
performing a first noise estimation based on a range fast Fourier transform (FFT) and a Doppler FFT before a digital beamforming on the first reflection signal, and to perform a second noise estimation based the range fast Fourier transform (FFT) before the Doppler FFT on the first reflection signal;
wherein the second channel includes one or more different time channels, different frequency channels, or different code dimensions from the first channel, and
wherein the code dimension of the first channel and the code dimension of the second channel is determined, from a set of code dimensions, based on a lowest interference noise estimation.
